(19) United States
(12) Patent Application Publication
(10) Pub. No.: US 2006/0048182 A1
(43) Pub. Date: Mar. 2, 2006

(54) Display device for displaying compensated program guide and method thereof

(75) Inventor: Je-ik Kim, Suwan-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/212,558

(22) Filed: Aug. 29, 2005

(30) Foreign Application Priority Data
Aug. 30, 2004 (KR) 2004-68435

(51) Int. Cl. H04N 5/445; G06F 13/00; G06F 3/00; H04N 5/44; H04N 5/50

(52) U.S. Cl. 725/38; 725/39; 348/731; 348/734

(57) ABSTRACT

A display device for displaying a program guide and a method thereof are provided. The display device includes: a tuner to select a first channel to receive a broadcasting signal; a signal processing unit to extract time information and EPG information from the broadcasting signal; a central processing unit to compute a time difference between a standard time and the extracted time information, and to compensate the extracted time information and EPG information using the time difference; and an output unit to display the compensated EPG information and time information.

### CROSS-REFERENCE TO RELATED APPLICATIONS

This application is based upon, and claims the benefit of priority under 35 U.S.C. § 119 (a) from, Korean Patent Application No. 2004-68435, filed on Aug. 30, 2004 in the Korean Intellectual Property Office, the disclosure of which is incorporated herein in its entirety by reference.

### BACKGROUND OF THE INVENTION

1. Field of the Invention

The invention generally relates to a display device for displaying a program guide and a method thereof. More particularly, the invention relates to a display device for compensating and displaying program guide and time information received from another broadcasting station using a predetermined reference time.

2. Description of the Related Art

Recently, particular digital cable broadcasting transmission and reception standards and digital cable data broadcasting interim standards have been determined and announced as the Telecommunications Technology Committee (TTC) standards. Digital TV broadcasting and service will be provided according to these standards in the near future.

Multi-channel broadcasting is one of the characteristics of digital broadcasting. A digital broadcasting system provides various broadcasting programs in a larger number of channels, that is, in tens to hundreds of channels, as compared with an existing analog broadcasting system. Thus, a guide is required so that a user can simply check the type of each program and information relating each program. To respond to this requirement, an electronic program guide (EPG) service has been is suggested.

The EPG service provides detailed information about a broadcast program through an unused frequency band or a channel through which a broadcasting signal is transmitted. The EPG service provides EPG information such as a broadcasting program schedule on a screen of a digital TV. When the user selects a specific broadcasting program title, the EPG service displays various pieces of more detailed information such as a channel number, broadcasting time, synopsis, and the like regarding the selected broadcasting program.

Each broadcasting station transmits additional data including EPG information along with video and voice data to support the EPG service. This EPG information may include a genre, title, broadcasting time, and the like. In this case, each broadcasting station transmits time information to be used as a standard time at which a program guide is displayed. However, in a case of a nation, such as the United States, where there are many time zones, time information displayed through a channel transmitting a program from another time zone will be different from the current time. Also, inaccurate time information may be transmitted by a broadcasting station frequently during re-broadcasting of programs, so that time information displayed through each channel, and a program broadcast according to the time information, vary, which may confuse the user.

FIG. 1 is a view of an example of the structure of a program guide displayed by a related art display device. Referring to FIG. 1, the program guide displays broadcasting times and program titles. When a user selects channel 11, a broadcasting signal transmitted from a first broadcasting station corresponding to the channel 11 is tuned to extract EPG information and time information from the broadcasting signal. Thus, a current time is set depending on the extracted time information, and EPG information 10 is displayed on a screen based on the current time. As shown through the channel 11, the current time is “August 19, 8:30.”

When the user selects channel 21 in this state, a current time is automatically set depending on time information transmitted from a second broadcasting station corresponding to the channel 21, and a program guide 20 broadcast through the channel 21 is displayed. However, since the second broadcasting station is in a different time zone that that of the user, the current time shown for channel 21 is “August 18, 10:00.” Thus, the user may be confused.

In order to prevent this confusion, the time information transmitted from the first broadcasting station may be stored to be continuously displayed so that the user can exactly check the current time. However, since the broadcasting times in the program guide 20 of the channel 21 are displayed depending on the time information transmitted from the second broadcasting station, the user may misunderstand which program is being broadcast through channel 21 at the current time “August 19, 08:30,” (e.g., the user may think that program γ is being broadcast, rather than the program δ that is actually being broadcast.

### BRIEF SUMMARY OF THE INVENTION

Accordingly, the general inventive concept herein is to solve the above-mentioned problems, and an aspect of the general inventive concept is to provide a display device for setting a time transmitted from a specific broadcasting station to a standard time and compensating EPG information transmitted from another broadcasting station using the standard time to display an exact program guide and a method thereof.

According to an aspect of the invention, there is provided a display device including: a tuner to select a first channel to receive a broadcasting signal; a signal processing unit to extract time information and electronic program guide (EPG) information from the broadcasting signal; a central processing unit to compute a time difference between a standard time and the extracted time information, and to cpmensate the extracted time information and EPG information using the time difference; and an output unit to display the compensated EPG information and time information.

The signal processing unit may extract the standard time from another channel selected before the first channel, or a key signal input unit may be used to directly set the standard time.

The EPG may include individual broadcast time intervals for a plurality of broadcast programs, and the central processing unit may reflect the time difference on each of the individual broadcasting time intervals.

The display device may further include a key signal input unit to input a standard time setting command. When the tuner selects the first channel and the standard time setting command is input, the central processing unit may set the extracted time information received through the first channel to the standard time.

The display device may further include a memory storing the standard time; and an on-screen display (OSD) generator generating an OSD for displaying the EPG information and the time information on the screen.

According to another aspect of the invention, there is provided a method of displaying a program guide, including: selecting a first channel to receive a broadcasting signal; extracting time information and EPG information from the broadcasting signal; computing a time difference between the extracted time information and a standard time; compensating the extracted time information and EPG information using the time difference; and displaying the compensated time information and EPG information.

The standard time may be extracted from another channel selected before the first channel, or may be directly set using an input button.

The EPG may include individual broadcast time intervals for a plurality of broadcast programs, and the compensating the extracted time information and EPG information using the time difference may include: reflecting the time difference on each of the individual broadcasting time intervals.

The method may further include, when the first channel is selected and a standard time setting command to set the standard time is input, setting the extracted time information received through the first channel to the standard time.

The method may further include storing the set standard time; and generating an OSD for displaying the compensated EPG information and time information on a screen.

### BRIEF DESCRIPTION OF THE DRAWINGS

The above and other aspects and features of the invention will be more apparent by describing certain embodiments of the invention with reference to the accompanying drawings, in which:

FIG. 1 illustrates an example of a program guide displayed by a related art display device;

FIG. 2 is a block diagram of a display device according to an exemplary embodiment of the invention;

FIG. 3 illustrates an exemplary program guide displayed by the display device of FIG. 2; and

FIG. 4 is a flowchart of a method of displaying a program guide according to an exemplary embodiment of the invention.

### DETAILED DESCRIPTION OF EXEMPLARY EMBODIMENTS

Certain exemplary embodiments of the invention will be described in greater detail below with reference to the accompanying drawings. The described exemplary embodiments are intended to assist the understanding of the invention, and are not intended to limit the scope of the invention in any way. Further, the same drawing reference numerals are used for the same elements even in different drawings, and well-known functions or constructions are not described in detail since they would obscure the invention in unnecessary detail.

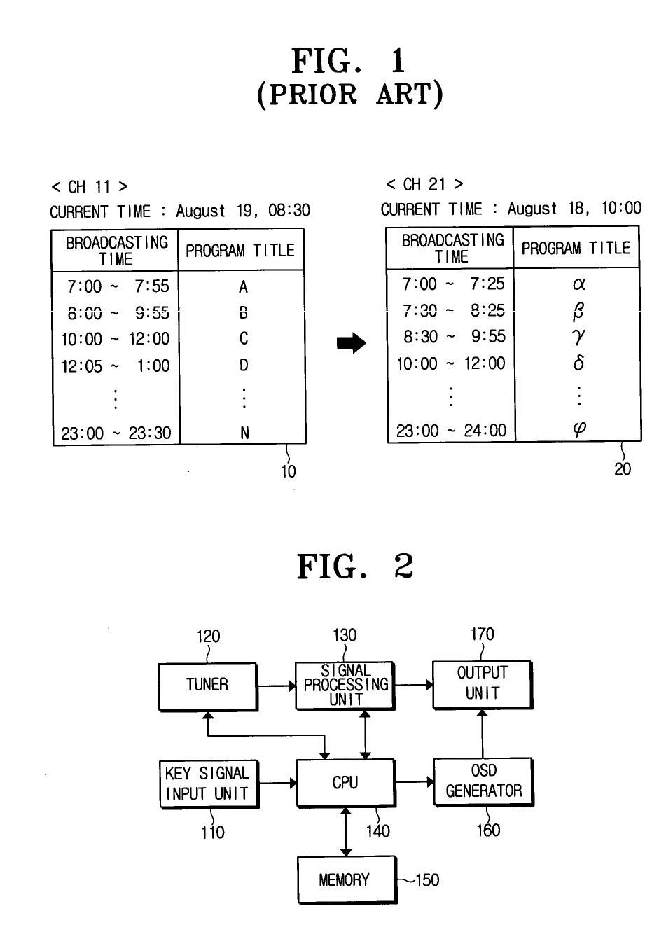

FIG. 2 is a block diagram of a display device according to an exemplary embodiment of the invention. Referring to FIG. 2, the display device includes a key signal input unit 110, a tuner 120, a signal processing unit 130, a central processing unit (CPU) 140, a memory 150, an on-screen display (OSD) generator 160, and an output unit 170.

The key signal input unit 110 recognizes various selection signals input by a user using a button key or a remote controller provided in a body of the display device, and informs the CPU 140 of the various selection signals. The user may control the operation of the display device via the key signal input unit 110.

The tuner 120 selects a channel selected by the user to receive a broadcasting signal through the selected channel. The broadcasting signal includes broadcasting data such as video data and sound data, and additional data such as time information and EPG information.

The signal processing unit 130 receives the broadcasting signal from the tuner 120 and extracts the additional data from the broadcasting signal. To be specific, the signal processing unit 130 demodulates and decodes the broadcasting signal in a way corresponding to modulation and coding configurations of a transmitter, and divides the demodulated and decoded broadcasting signal into the video data, the sound data, and the additional data. The signal processing unit 130 decodes the video and sound data and signal-processes the decoded video and sound data so as to be displayed to the outside by the output unit 170.

The CPU 140 checks the time information of the additional data extracted by the signal processing unit 130 and compares the time information with a predetermined standard time. The CPU 140 computes a time difference between the standard time and the time information and compensates the time information and the EPG information by reflecting the time difference.

In this embodiment, the user may directly input the standard time through the key signal input unit 110. For example, when a channel is selected and displayed on a screen, the user may input a standard time setting command through the key signal input unit 110 to set time information received through the selected channel to be the standard time. The CPU 140 may store the set standard time in the memory 150 to use the standard time for compensating time information and EPG information newly received whenever the user changes the selected channel into another channel.

When the CPU 140 receives a command to display a program guide from the user, the CPU 140 controls the output unit 170 to display the compensated time information and EPG information. The CPU 140 may compensate and display broadcasting time information of each program in the EPG information using the time difference between the received time information and the standard time. In this case, the CPU 140 may display the compensated EPG information in an OSD form using the OSD generator 160.

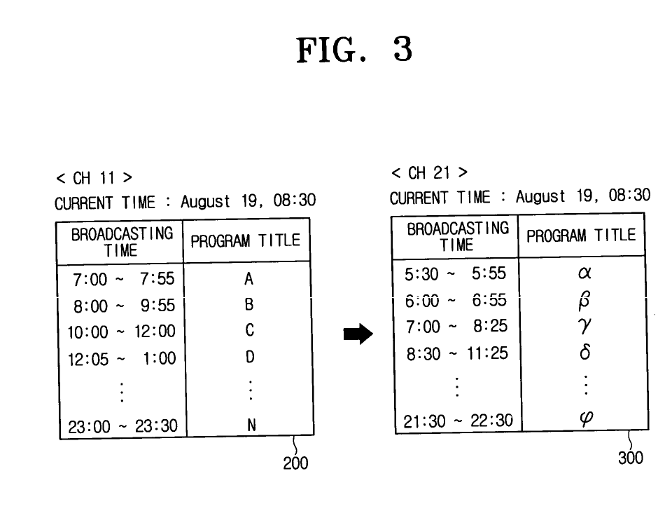

FIG. 3 illustrates an example of the structure of a program guide displayed by the display device shown in FIG. 2. Referring to FIG. 3, time information received through channel 11 is “August 19, 08:30,” which is set as the current time and displayed in program guide 200 on a screen. Broadcasting times, program titles, and the like may also be displayed in the program guide 200. Since the current time is “8:30,” the program guide 200 indicates that a program currently being broadcast is program “B.”

If the user determines that the time information received through the channel 11 is correct, the user may select the standard time setting command through the key signal input unit 110 to set the received time information to a standard time.

When the user changes the channel 11 into channel 21 in this state, the tuner 120 selects the channel 21 to receive a broadcasting signal through the channel 21. As shown in FIG. 1, time information included in the broadcasting signal received through the channel 21 is “August 18, 10:00.”

The CPU 140 computes a time difference between the standard time and the received time information. As shown in FIGS. 1 and 3, the time difference is “22:30.” The CPU 140 compensates the received time information and EPG information using the time difference. In detail, the CPU 140 adds the time difference with the time information to set the current time to “August 19, 08:30.” The CPU 140 adds the time difference with each broadcasting time in the EPG information to compensate the EPG information. Thus, a compensated program guide is displayed so that the user can recognize that program 6 starts at the current time “08:30.”

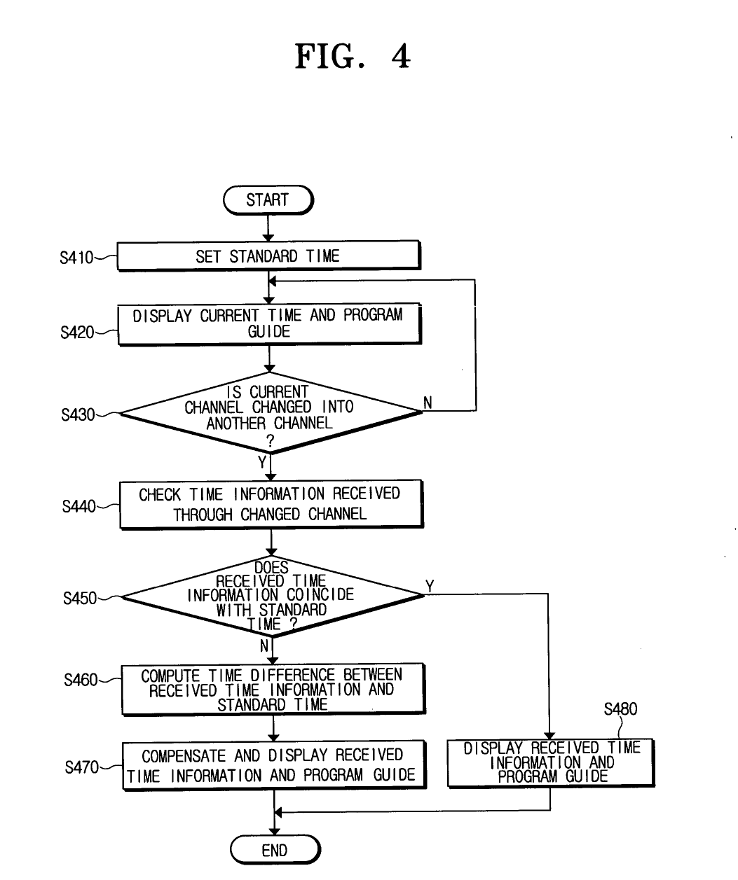

FIG. 4 is a flowchart of a method for displaying a program guide according to an exemplary embodiment of the invention. Referring to FIG. 4, in operation S410, a user sets time information received through a first channel to a standard time. In this case, the user may directly input time using various button keys such as a figure key or the like to set the standard time.

When the user inputs a selection signal for requesting to display a program guide, in operation S420, current time information and EPG information is displayed on a screen.

In operation S430, it is determined whether the first channel is changed into another channel. If it is determined in operation S430 that the first channel is changed into the another channel, in operation S440, time information received through the changed channel is checked. In operation S450, it is determined whether the received time information coincides with the standard time. If it is determined in operation S450 that the received time information coincides with the standard time, in operation S480, the CPU 140 sets the received time information to a current time and displays EPG information and the current the current time received through the changed channel on the screen.

If it is determined in operation S450 that the received time information does not coincide with the standard time, in operation S460, the CPU 140 computes a time difference between the received time information and the standard time.

In operation S470, the CPU 140 compensates and displays the time information and EPG information received through the changed channel using the time difference.

Therefore, although a channel transmitting inaccurate time information is selected, exact time information and program broadcasting time can be checked.

As described above, in a display device for displaying a compensated program guide and a method thereof according to an embodiment of the invention, time information received through a predetermined channel can be set to a standard time to compensate time information received through another channel using the standard time. Although a user selects various channels, time information and a program guide can be always exactly displayed. As a result, when the user selects a program the user desires to view, the user can be prevented from being confused.

The foregoing embodiment and advantages are merely exemplary and are not to be construed as limiting the invention. The teaching can be readily applied to other types of apparatuses. Also, the description of the embodiments of the invention is intended to be illustrative, and not to limit the scope of the claims, and many alternatives, modifications, and variations will be apparent to those skilled in the art.

What is claimed is:

1. A display device comprising:
a tuner to select a first channel to receive a broadcasting signal;
a signal processing unit to extract time information and electronic program guide (EPG) information from the broadcasting signal;
a central processing unit to compute a time difference between a standard time and the extracted time information, and to compensate the extracted time information and EPG information using the time difference; and
an output unit to display the compensated EPG information and time information.

2. The display device of claim 1, wherein the signal processing unit extracts the standard time from another channel selected before the first channel.

3. The display device of claim 1, further comprising a key signal input unit to directly set the standard time.

4. The display device of claim 1, wherein the EPG comprises individual broadcast time intervals for a plurality of broadcast programs, and the central processing unit reflects the time difference on each of the individual broadcasting time intervals.

5. The display device of claim 1, further comprising a key signal input unit to input a standard time setting command,
wherein, when the tuner selects the first channel and the standard time setting command is input, the central processing unit sets the extracted time information received through the first channel to the standard time.

6. The display device of claim 5, wherein the key signal input unit directly inputs standard time information.

7. The display device of claim 1, further comprising:
a memory storing the standard time; and
an on-screen display (OSD) generator generating an OSD for displaying the EPG information and the time information on a screen.

8. A method of displaying a program guide, comprising:
selecting a first channel to receive a broadcasting signal;
extracting time information and electronic program guide (EPG) information from the broadcasting signal;
computing a time difference between the extracted time information and a standard time;
compensating the extracted time information and EPG information using the time difference; and
displaying the compensated time information and EPG information.

9. The method of claim 8, further comprising extracting the standard time from another channel selected before the first channel.

10. The method of claim 8, further comprising directly setting the standard time using an input button.

11. The method of claim 8, wherein the EPG comprises individual broadcast time intervals for a plurality of broadcast programs, and the compensating the extracted time information and EPG information using the time difference comprises reflecting the time difference on each of the individual broadcasting time intervals.

12. The method of claim 8, further comprising, when the first channel is selected and a standard time setting command to set the standard time is input, setting the extracted time information received through the first channel to the standard time.

13. The method of claim 12, further comprising setting the standard time directly using an input button.

14. The method of claim 13, further comprising:
storing the set standard time; and
generating an on-screen display (OSD) for displaying the compensated EPG information and time information on a screen.
